(19) United States
(12) Patent Application Publication
(10) Pub. No.: US 2009/0138647 A1
(43) Pub. Date: May 28, 2009

(54) BUS SWITCH, ELECTRONIC EQUIPMENT, AND DATA TRANSFER METHOD

(76) Inventor: Yasuharu HAGITA, Tokyo (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/266,697

(22) Filed: Nov. 7, 2008

(30) Foreign Application Priority Data
Nov. 26, 2007 (JP) 2007-304430
Oct. 2, 2008 (JP) 2008-257428

(51) Int. Cl. G06F 13/00

(52) U.S. Cl. 710/316

(57) ABSTRACT

A serial transfer interface bus switch provided between a memory control unit which controls reading and writing of data with the memory, and multiple process control units which process the data is disclosed. The bus switch includes one or more first data transmitting and receiving units provided for each of the process control units for controlling data transmitting and receiving with the process control units; a second transmitting and receiving unit which controls data transmitting and receiving with the memory control unit; and a switching unit which switches between a connection to the first data transmitting and receiving unit and a connection to the second data transmitting and receiving unit. The first data transmitting and receiving unit has a buffer of a size no less than an amount of data which can be transferred with the memory in one instruction from the process control units.

### TECHNICAL FIELD

The present invention generally relates to a bus switch, electronic equipment, and a data transfer method, and more specifically relates to a bus switch of a serial transfer interface, electronic equipment having the bus switch, and a data transfer method in the bus switch.

### BACKGROUND ART

For example, some copiers, printers and personal computers as examples of electronic equipment units use a serial transfer interface instead of a PCI bus. An example of the serial transfer interface is PCIe (PCI Express). In the electronic equipment units which use the PCIe, seeking to improve the equipment performance could cause the data transfer performance of the PCIe to be a bottleneck.

Patent document 1 discloses connecting multiple memories to a PCIe bus switch to distribute memory access, thus preventing a shortage of memory bus bandwidth, and distributing the data transfer load.

Patent document 1

JP2005-332372A

There are related-art methods of increasing the number of bus lanes and increasing the operating frequency in order to increase the data transfer performance of the PCIe. However, such methods of increasing the number of bus lanes and increasing the operating frequency involves significant device changes and have the following effects on development cost, personnel, manpower, and risk.

As the effect on the development cost, there is a problem that logical-layer and physical-layer IPs need to be newly developed or procured. As the effect on the personnel, there is a problem that human resources need to be secured for device development. As the effect on manpower, there is a problem that a few months of manpower are needed for the device development. Moreover, as the effect on risk, there is also a problem that old-device operating performance cannot be applied for the device development.

In cited document 1, a shortage of memory bus bandwidth may be prevented, but a shortage of PCIe bus bandwidth may not. Thus, the related art has a problem that the PCIe data transfer performance cannot be improved easily.

### DISCLOSURE OF THE INVENTION

In light of the above, the present invention aims to provide a bus switch, an electronic equipment unit, and a data transfer method that allows easily improving the data transfer performance of a serial transfer interface.

In order to solve the problem as described above, the present invention provides a serial transfer interface bus switch provided between a memory control unit which controls reading and writing of data with the memory, and multiple process control units which process the data, including, one or more first data transmitting and receiving units provided for each of the process control units for controlling data transmitting and receiving with the process control units; a second transmitting and receiving unit which controls data transmitting and receiving with the memory control unit; and a switching unit which switches between a connection to the first data transmitting and receiving unit and a connection to the second data transmitting and receiving unit, wherein the first data transmitting and receiving unit has a buffer of a size no less than an amount of data which can be transferred with the memory in one instruction from the process control units.

Moreover, the present invention provides an electronic equipment unit having a memory control unit which controls reading and writing of data with a memory, and a plurality of process control units which process the data, including, a serial-transfer interface bus switch between the memory control unit and the plurality of process control units, the bus switch having: one or a plurality of first data transmitting and receiving units provided for each of the process control units for controlling data transmitting and receiving with the process control units; a second transmitting and receiving unit which controls data transmitting and receiving with the memory control unit; and a switching unit which switches between a connection to the first data transmitting and receiving unit and a connection to the second data transmitting and receiving unit, wherein the first data transmitting and receiving unit has a buffer of a size no less than an amount of data which can be transferred with the memory in one instruction from the process control units.

Furthermore, the present invention provides a method of transferring data in a serial transfer interface bus switch provided between a memory control unit which controls reading and writing of data with a memory, and a plurality of process control units which process the data, including the steps of, receiving from the process control units, by one or a plurality of first data transmitting and receiving units which control data transmitting and receiving with the process control units, an instruction of reading from the memory; transmitting, by the second data transmitting and receiving unit which controls transmitting and receiving of data with the process control units, the reading instruction to the memory control unit; receiving from the memory control unit, by the second data transmitting and receiving unit, the data read from the memory according to the reading instruction; transmitting, by a switching unit which switches between a connection to the first data transmitting and receiving unit and a connection to the second data transmitting and receiving unit, the data received from the memory control unit to the first data transmitting and receiving unit which transmitted the reading instruction; and transmitting, by the first transmitting and receiving unit, the data to the process control units using a buffer of a size no less than an amount of data which can be transferred with the memory with one instruction from the process control units.

The present invention may also take a form such that elements, representations, or arbitrary combinations of the elements of the present invention are applied to a method, an apparatus, a system, a computer program, a recording medium, or data structure.

The present invention allows providing a bus switch, an electronic equipment unit, and a data transfer method that easily improve the data transfer performance of a serial transfer interface.

### BRIEF DESCRIPTION OF THE DRAWINGS

Other objects, features, and advantages of the present invention will become more apparent from the following detailed descriptions when read in conjunction with the accompanying drawings, in which:

FIG. 1 is a schematic drawing of an example of a prior-art printer;

FIG. 2 is a schematic drawing of an example of a printer according to the present invention;

FIG. 3 is a timing chart of data transfer performed in a related-art printer;

FIG. 4 is a timing chart of data transfer performed in a printer according to the present invention;

FIG. 5 is a schematic diagram showing a PCIe bus switch configuration and data flow;

FIG. 6 is a schematic drawing of an example showing how ports of a bus switch are mapped to respectively corresponding memory spaces;

FIG. 7 is a timing chart for data transfer for a bus switch without buffers therein;

FIG. 8 is a timing chart for data transfer with pre-casting of read commands for a bus switch with the buffers therein;

FIG. 9A is a timing chart for data transfer for large units (packets) of transferring data;

FIG. 9B is a timing chart for data transfer for small units (packets) of transferring data;

FIG. 10 is a schematic drawing of another embodiment of the printer according to the present invention;

FIG. 11 is a timing chart with different transfer rates for data transfer performed in the printer according to the present invention; and

FIG. 12 is a schematic drawing of a further embodiment of the printer according to the present invention.

### BEST MODE FOR CARRYING OUT THE INVENTION

Descriptions are given next, with reference to the accompanying drawings, of embodiments of the present invention.

The present invention is not limited to the specifically disclosed embodiments, but variations and modifications may be made without departing from the scope of the present invention. While the present embodiment is illustrated with reference to a printer, which is an image processing apparatus as an example of an electronic equipment unit, any electronic equipment unit may be provided. First, an example of a configuration of a prior-art printer is described in order to facilitate understanding the present invention.

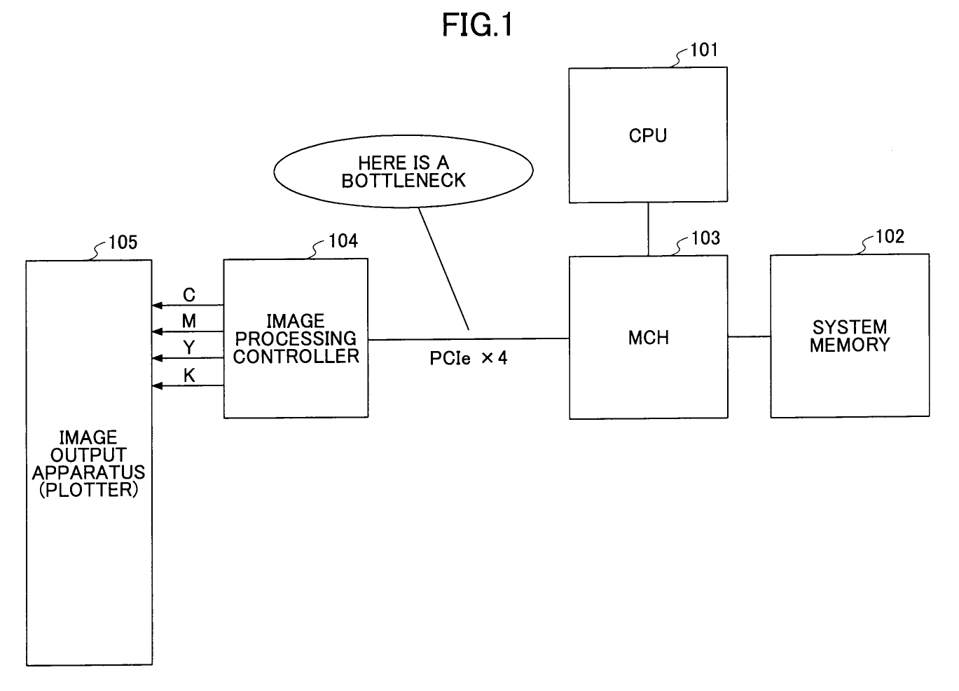

FIG. 1 is a schematic drawing of an example of the prior-art printer. The schematic drawing as described above omits some of the parts which are not necessary for explaining the present invention. The printer shown in FIG. 1 is arranged to include a CPU 101, a system memory 102, an MCH (memory controller hub) 103, an image processing controller 104, and an image output apparatus (a plotter) 105.

The MCH 103 is a chipset for a memory interface (I/F). In the MCH 103 of the present embodiment, a PCIe I/F port allows a connection of up to 8 lanes. A lane is a minimally-configured transmission path used in the PCIe. A port is arranged to bundle multiple lanes. The image processing controller 104 is a device which compresses, scales, color-converts, and gray scales an image. The image output apparatus 105 is an apparatus which forms an image on a medium such as paper based on data (image data).

The CPU 101, system memory 102, and image processing controller 104 are connected via the MCH 103. Moreover, the image processing controller 104 is connected to the image output apparatus 105. The image processing controller 104 performs various image processing using the system memory 102. Moreover, the image processing controller 104 also serves to output data of the system memory 102 to the image output apparatus 105. In the image processing controller 104 of the present embodiment, a PCIe I/F port allows a connection of up to 4 lanes.

Thus, in the related-art printer in FIG. 1, the MCH 103 and image processing controller 104 are, system-performance wise, connected by a four-lane PCIe “PCIe×4”. For building a higher-performance system to improve the printer performance, a shortage of the PCIe bus bandwidth may occur with the related-art printer shown in FIG. 1. The four-lane PCIe between the MCH 103 and the image processing controller 104 may become a bottleneck.

In the related-art printer shown in FIG. 1, there is a problem that the image processing controller 104 cannot easily be changed to allow a connection of up to 8 lanes for the PCIe I/F port connection even when it is found that a PCIe I/F port which allows a connection of 8 lanes is needed to avoid a bus bandwidth shortage.

### Embodiment 1

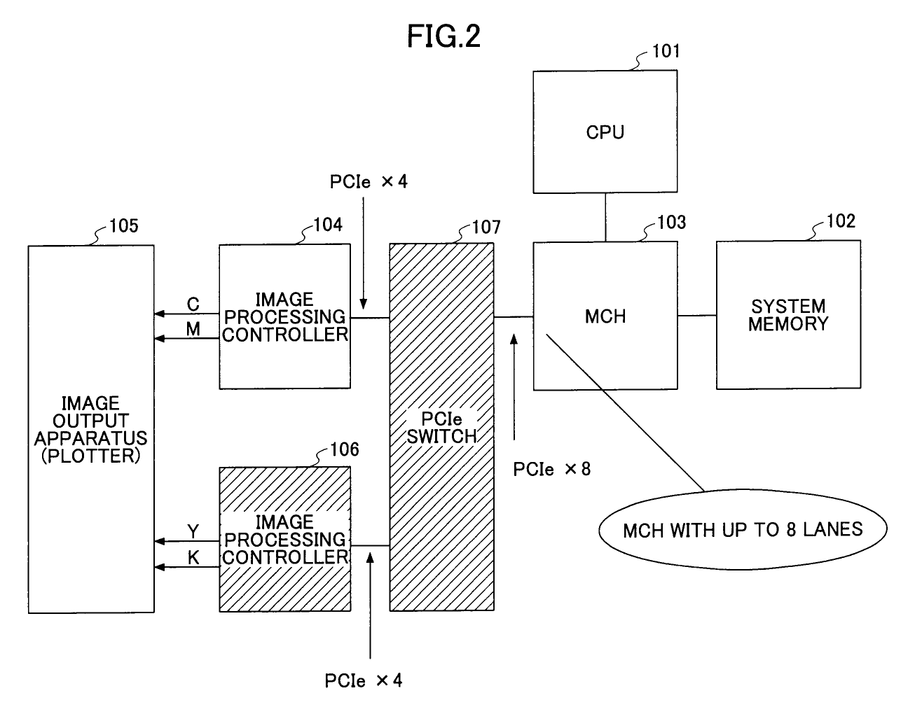

FIG. 2 is a schematic drawing of an embodiment of a printer of the present invention. The schematic drawing in FIG. 2 omits some of the parts which are not necessary for explaining the present invention. The printer in FIG. 2 is arranged to have a CPU 101, a system memory 102, an MCH 103, an image processing controller 104, an image output apparatus 105, an image processing controller 106, and a PCIe bus switch 107.

The printer shown in FIG. 2 is arranged to add the image processing controller 106 and the PCIe bus switch 107 to the printer in FIG. 1. Similar to the image processing controller 104, the image processing controller 106 is a device which compresses, scales, color-converts, and gray scales an image. The PCIe bus switch 107 connects two or more ports and route packets among the ports.

The bus switch 107 according to the present embodiment has three ports, one of which is on the upstream side allowing a connection of up to 8 lanes and the others on the downstream side allowing a connection of up to 4 lanes.

In the printer shown in FIG. 2, the PCIe bus switch 107 is arranged between the MCH 103 and the image processing controllers 104, 106. The image processing controller 106, which may be what the load of image processing controller 104 may be distributed to, may be the same device as the image processing controller 104, or a different device.

The image processing controllers 104 and 106 are both connected to the bus switch 107 by 4 PCIe lanes. Moreover, the MCH 103 and the bus switch 107 by 8 PCIe lanes. In the printer shown in FIG. 2, the number of lanes connecting the image processing controllers 104 and the bus switch 107 is larger than the number of lanes connecting the MCH 103 and the bus switch 107.

In the printer shown in FIG. 2, it is desirable that the number of lanes connecting the MCH 103 and the bus switch 107 is no less than twice the number of lanes connecting the image processing controller 104 and the bus switch 107. In a printer in which N (where N is a plurality) image processing controllers 104 are connected to the bus switch 107, it is desirable that the number of lanes connecting the MCH 103 and the bus switch 107 is no less than N times the number of lanes connecting the image processing controller 104 and the bus switch 107 (in other words, the transfer rate is no less than N times).

In the printer of the present invention, multiple devices (image processing controllers 104, 106) which access the system memory 102 as a master are connected to the PCIe bus switch 107 and the number of lanes connecting each device 103 and the bus switch 107 is set as “4” and the number of lanes connecting the MCH 103 and the bus switch 107 is set as “8”, which is larger than “4”, to provide the transfer-rate difference to overcome the bottleneck in the PCIe.

The essential use of the PCIe bus switch 107 is to connect multiple modules (functions) to one bus. However, in the printer shown in FIG. 2, a multiple number of the same modules are connected to enhance the data transfer performance. In the printer shown in FIG. 2, as in the printer shown in FIG. 1, the existing image processing controllers 104, 106 with four PCIe lanes may be used, making it possible to minimize the development cost, personnel, manpower, and risk to improve the data transfer performance of PCIe. Thus, in the printer as shown in FIG. 2, the equipment performance may easily be improved.

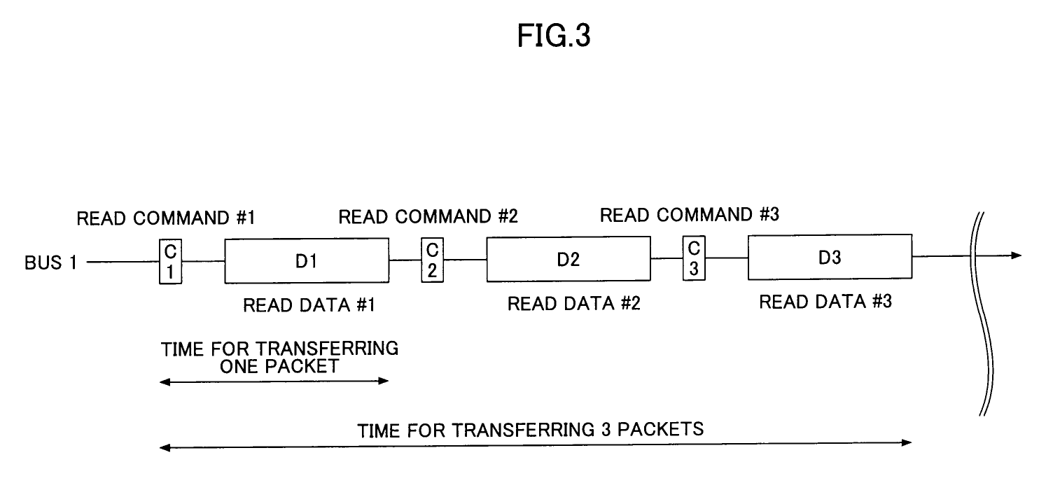

FIG. 3 is a timing chart of data transfer performed in a related-art printer. In FIG. 3, there is a PCIe bus between the MCH 103 and the image processing controller 104, which is called “a bus 1”. The timing chart of FIG. 3 shows an operation of the “bus 1” for the image processing controller 104 reading output image data from the system memory 102 upon receiving a start request from the CPU 101.

First, the CPU 101 accesses a register (not shown) within the image processing controller 104, and starts the image processing controller 104. The image processing controller 104 issues a read command (C1) for the system memory 102 to the MCH 103. The MCH 103, upon receiving the read command (C1), reads data of a designated address from the system memory 102.

The MCH 103 returns the read data (D1) from the system memory 102 to the image processing controller 104 as a PCIe response to the read command (C1). The image processing controller 104 image-processes the data (D1) received from the MCH 103 to send the data to the image output apparatus 105. The image output apparatus 105 outputs the received data on paper.

In parallel with the process of image processing the data (D1) received from the MCH 103 to send to the image output apparatus 105, the image processing controller 104 issues a next read command (D2) for the system memory 102 to the MCH 103. Below, the related-art printer continues the process in the same manner as the process for the read command (C1).

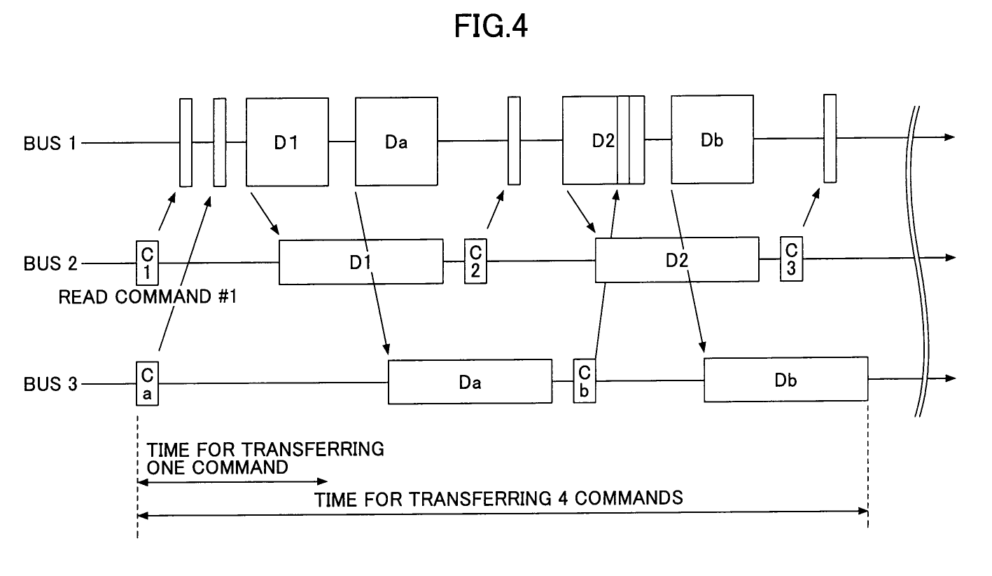

FIG. 4 is a timing chart of data transfer performed in a printer of the present invention. In FIG. 4, a PCIe bus between the MCH 103 and the bus switch 107 is shown as “bus 1”, a PCIe bus between the image processing controller 104 and the bus switch 107 is shown as “bus 2”, and a PCIe bus between the image processing controller 106 and the bus switch 107 is shown as “bus 3”.

The timing chart of FIG. 4 shows operations of the buses 1-3 for reading output image data from the system memory 102 upon the image processing controllers 104 and 106 receiving a start request from the CPU 101. In the timing chart of FIG. 4, the image processing controllers 104 and 106 handle different output images. For example, when the printer handles CMYK 4 plane data, the image processing controller 104 handles C and M planes, while the image processing controller 106 handles Y and K planes. When the printer prints both sides simultaneously, the image processing controller 104 may handle the front side (face), while the image process controller 106 may handle the back side (face).

First, the CPU 101 accesses registers (not shown) within the image processing controllers 104 and 106, and starts the image processing controllers 104 and 106. The image processing controller 104 issues a read command (C1) for the system memory 102 via the bus 2 to the MCH 103. The image processing controller 106 issues a read command (Ca) for the system memory 102 via the bus 3 to the MCH 103.

The bus switch 107 sends two read commands (C1, Ca) sequentially to the MCH 105 via bus 1 without processing. The MCH 103, upon receiving the read commands (C1, Ca), reads data of designated addresses from the system memory 102.

The MCH 103 returns the read data sets (D1, Da) from the system memory 102 as PCIe responses to the read commands (C1, Ca) via the bus 1 to the bus switch 107.

The bus switch 107 returns the received data (D1) to the image processing controller 104, from which the read command (C1) is requested, via the bus 2. Moreover, the bus switch 107 returns the received data (Da) to the image processing controller 106, from which the read command (Ca) is requested, via the bus 3.

While data (D1) received from the bus switch 107 is image-processed to pass on to the image output apparatus 105, the image processing controller 104 issues a next read command (C2). While the data (D1) received from the bus switch 107 is image-processed to pass on to the image output apparatus 105, the image processing controller 106 issues a next read command (Cb).

Upon receiving data image-processed by the image processing controller 104 or 106, the image output apparatus 105 prints the received data on paper. In a manner similar to the read commands (C1, Ca), the read commands (C2, Cb) are conveyed to the MCH 103. Below, the printer according to the subject application continues the process in the same manner as the process for the read commands (C1, Ca).

In the timing chart indicated in FIG. 4, bus 1 data (D2) and read command (Cb) overlap. However, PCIe buses, which allow a full-duplex transfer with separate transmit and receive buses, makes simultaneous transfer possible.

Compared to that for buses 2 and 3, the number of buses or the bandwidth for bus 1 is greater, so that the efficiency of data transfer in the timing chart of the printer according to the present invention in FIG. 4 is greater than that in the timing chart of the related-art printer in FIG. 3.

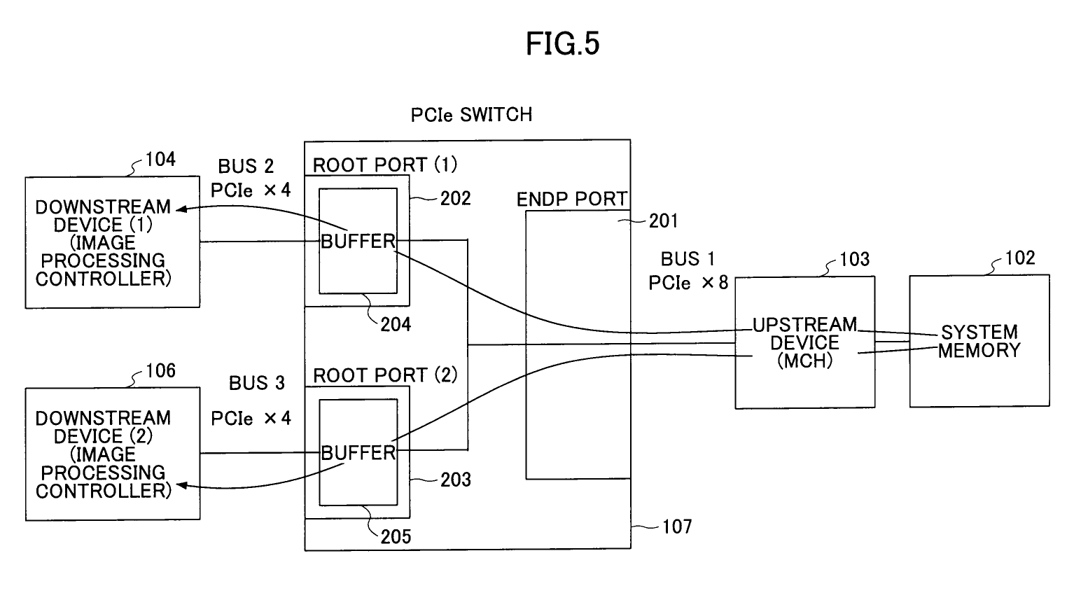

FIG. 5 is a schematic diagram showing a PCIe bus switch configuration and data flow. The PCIe bus switch 107 in FIG. 5 has three ports 201-203. An upstream (ENDP) port 201 is connected to the MCH 103, which is an upstream device, with an 8-lane “PCIe×8”. Downstream (ROOT) ports 202 and 203 are connected to the image processing controllers 104 and 106 which are downstream devices, with a 4-lane “PCIe×4”.

The downstream (ROOT) ports 202 and 203 have buffers 204, 205, used in transmitting and receiving data. If the sizes of the buffers 204 and 205 are only a size of one transfer (an amount of data that can be transferred in one command, which may be 4 k byte, for example), a maximum performance is achieved when read commands are alternately issued from the image processing controllers 104 and 106, which are downstream devices.

However, when read commands are not alternately issued from the image processing controllers 104 and 106, which are downstream devices (or when the same downstream device successively issues the read commands), the buffer 204 or 205 corresponding to the read-command originator becomes full, so that the next data transfer remains in the wait state until the buffer 204 or 205 corresponding to the read-command originator becomes available.

If the sizes of the buffers 204 and 205 are no less than a size of N transfers (an amount of data that can be transferred in N commands), a degradation in data transfer performance is prevented even when read commands are not alternately issued from the image processing controllers 104 and 106, which are downstream devices. More specifically, if the sizes of the buffers 204 and 205 are no less than a size of N transfers, even when the same downstream device successively issues the read commands N times, the buffer 204 or 205 corresponding to the read-command originator does not become full, so that the next data transfer is not put in the wait state.

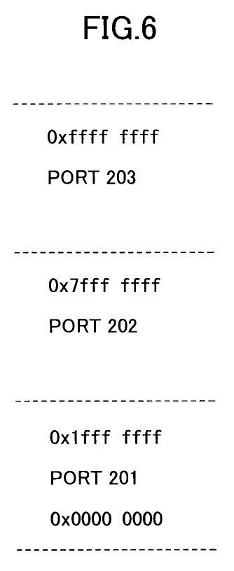

Now, an operation of the PCIe bus switch 107 is described. The ports 201-203 of the bus switch 107 are mapped to corresponding memory spaces as shown in FIG. 6, for example. FIG. 6 is a schematic drawing of an example showing how the ports of the bus switch are mapped to corresponding memory spaces. The mapping to the memory spaces are performed by a configuration (a general PCI configuration) for each of the ports 201-203 at the time of starting.

For example, assuming that a bus switch having the ports 201 to 203 is mapped to corresponding memory spaces as shown in FIG. 6, accessing the address space (for example, 0×3000 0000) of the port 202 from an upstream device connected to the port 201 leads to connecting to a downstream device connected to the port 202. In other words, a downstream device connected to the port 202 may be accessed from an upstream device connected to the port 201.

The PCIe bus switch 107 does not have to be based on a memory-mapping scheme, and thus, setting offsets for individual access windows to map all address spaces for each of the ports 201-203 may be possible. The bus switch 107 according to the present invention does not have to be dependent on a switching method, so that it can appropriately switch connections (paths) among the ports 201-203.

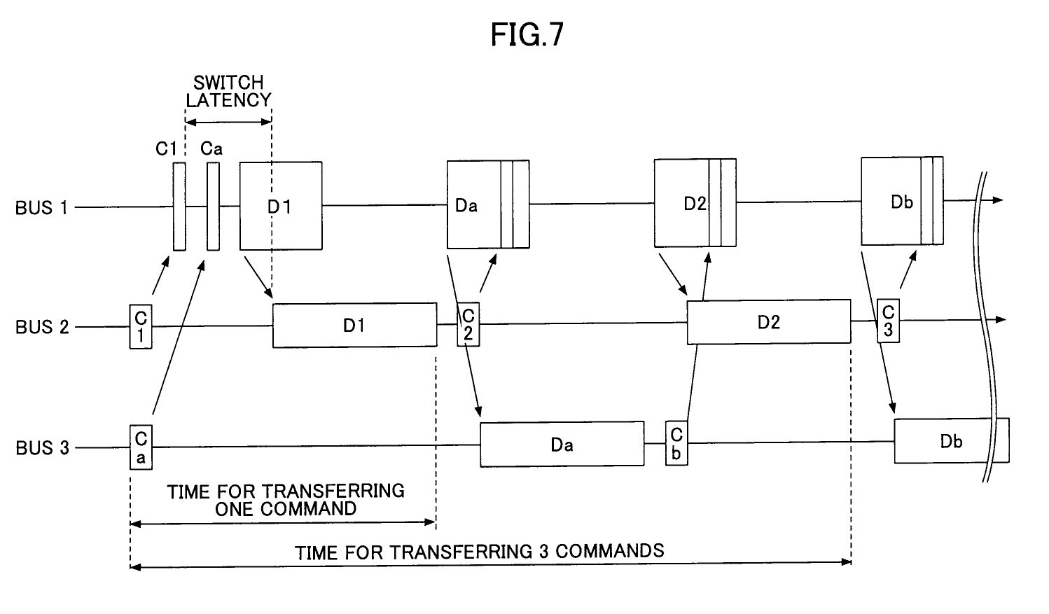

Next, timing charts for data transfer for the bus switch 107 with the buffers 204 and 205, and for the bus switch 107 without them are explained. FIG. 7 shows a timing chart for the data transfer for the bus switch without the buffers therein. A timing chart for data transfer for the bus switch 107 with the buffers 204 and 205 is as shown in FIG. 4.

A timing chart for data transfer for the bus switch 107 without the buffers 204 and 205 are explained with reference to FIG. 7. The timing chart in FIG. 7 shows that, on “bus 1”, read commands (C1, Ca) are issued one after another, and thus the received data sets (D1, Da) amount to one each as there are no buffers 204, 205 inside the bus switch 107.

In the timing chart in FIG. 7, data (Da) cannot be received on “the bus 1” until the bus switch 107 receives data (D1) on “the bus 1”, and sending of the data (D1) to the image processing controller 104 on “the bus 2” is completed.

In other words, an own latency of the bus switch 107 without the buffers 204, 205 causes a degradation in data transfer performance. Moreover, a successive transfer of multiple read commands does not lead to an improvement in the data transfer performance. The latency herein is a time between when a read command is issued to when data is returned to the read-command originator.

An own latency of the bus switch 107 with the buffers 204, 205 also causes a degradation in data transfer performance. However, data can be pre-read using the buffers 204, 205. Thus, successively transferring multiple read commands allows offsetting of the own latency, and improving the data transfer performance.

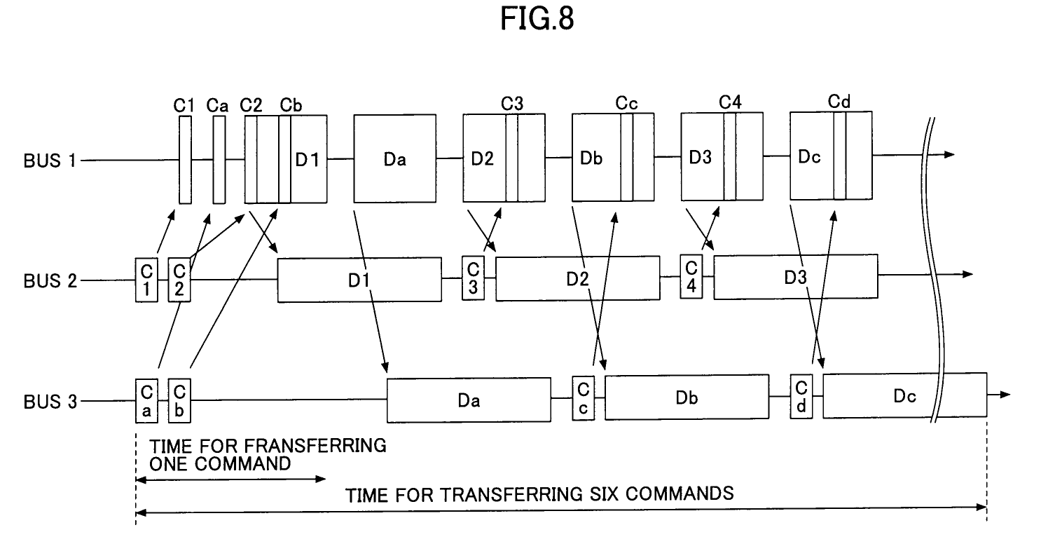

Next, a timing chart with pre-casting of read commands from the image processing controllers 104 and 106 for the bus switch 107 with the buffers 204 and 205 therein is described. FIG. 8 shows a timing chart for the data transfer with pre-casting therein. The pre-casting of read commands herein means issuing a next read command before a downstream device which is a read-command originator receives data for the previous read command.

The timing chart of FIG. 8 shows operations of the buses 1-3 for reading output image data from the system memory 102 upon the image processing controllers 104 and 106 receiving a start request from the CPU 101. In the timing chart of FIG. 8, upon receiving the start request from the CPU 101, the image processing controllers 104 and 106 successively issues multiple (two in FIG. 8) read commands before receiving previously-issued read command data (response data) to pre-cast the read commands.

First, the CPU 101 accesses registers (not shown) within the image processing controllers 104 and 106, and starts the image processing controllers 104 and 106. The image processing controller 104 issues read commands (C1, C2) for the system memory 102 via the bus 2 to the MCH 103. The image processing controller 106 issues read commands (Ca, Cb) for the system memory 102 via the bus 3 to the MCH 103. The bus switch 107 sends the received four read commands (C1, Ca, C2, Cb) to the MCH 103 via bus 1 sequentially without processing.

The MCH 103, upon receiving the read commands (C1, Ca, C2, Cb), reads data of designated addresses (D1, Da, D2, Db) from the system memory 102. The MCH 103 returns the read data sets (D1, Da) from the system memory 102 as PCIe responses to the read commands (C1, Ca) via the bus 1 to the bus switch 107.

FIG. 8 shows an example of the buffers 204 and 205 having one transfer size. Therefore, at this time, the data read (D2, Db) from the systems memory 102 is not returned to the bus switch 107.

The bus switch 107 returns the received data (D1) to the image processing controller 104, from which the read command (C1) is requested, via the bus 2. Moreover, the bus switch 107 returns the received data (Da) to the image processing controller 106, from which the read command (Ca) is requested, via the bus 3.

While data (D1) received from the bus switch 107 is image-processed to pass on to the image output apparatus 105, the image processing controller 104 issues a next read command (C3). While the data (Da) received from the bus switch 107 is image-processed to pass on to the image output apparatus 105, the image processing controller 106 issues a next read command (Cc). In a manner similar to the read commands (C1, Ca), the read commands (C3, Cc) are conveyed to the MCH 103.

In the bus switch 107, the buffer 204 becomes available when transferring of the data (D1) is completed in “bus 2”, so that transferring of the data (D2) starts in “bus 1”. The image processing controller 104 starts receiving the data (D2) immediately after issuing the read command (C3).

Moreover, the buffer 205 becomes available when transferring of the data (Da) is completed in “bus 3”, so that transferring of the data (Db) starts in “bus 1”. The image processing controller 106 starts receiving the data (Db) immediately after issuing the read command (Cc).

Upon receiving data image-processed by the image processing controller 104 or 106, the image output apparatus 105 prints the received data on paper. Below, the printer according to the subject application continues the process in the same manner as the process for the read commands (C1, Ca).

In this way, in the timing chart of the printer according to the present invention as shown in FIG. 8, the image processing controllers 104 and 106 pre-cast the read command to effectively use the bus bandwidth of the “bus 1”, thus further improving the efficiency of transferring data.

A further improvement in the efficiency of transferring data may be achieved by increasing the number of image processing controllers 104 and 106, which are downstream devices, increasing the sizes of the buffers 204, 205, or increasing the number of read commands pre-cast by the image processing controllers 104 and 106, which are downstream devices. For increasing the number of image processing controllers 104, 106, which are downstream devices, the narrower the bus bandwidth of “the bus 1”, the smaller the effect.

Now, with the bus switch 107 according to the present invention, the smaller the unit (a packet) for transferring data, the lower the effectiveness of using the bus bandwidth of “the bus 1”, and thus lower the efficiency of transferring data. Now, the timing charts for the data transfer for large and small units (packets) of transferring data in the bus switch 107 according to the present invention is described.

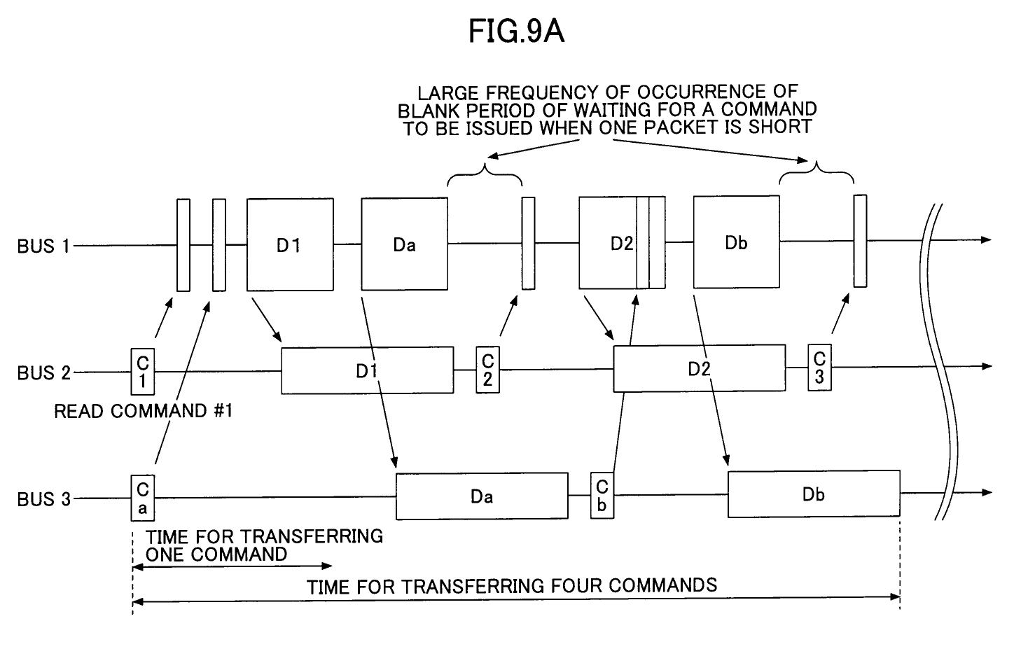

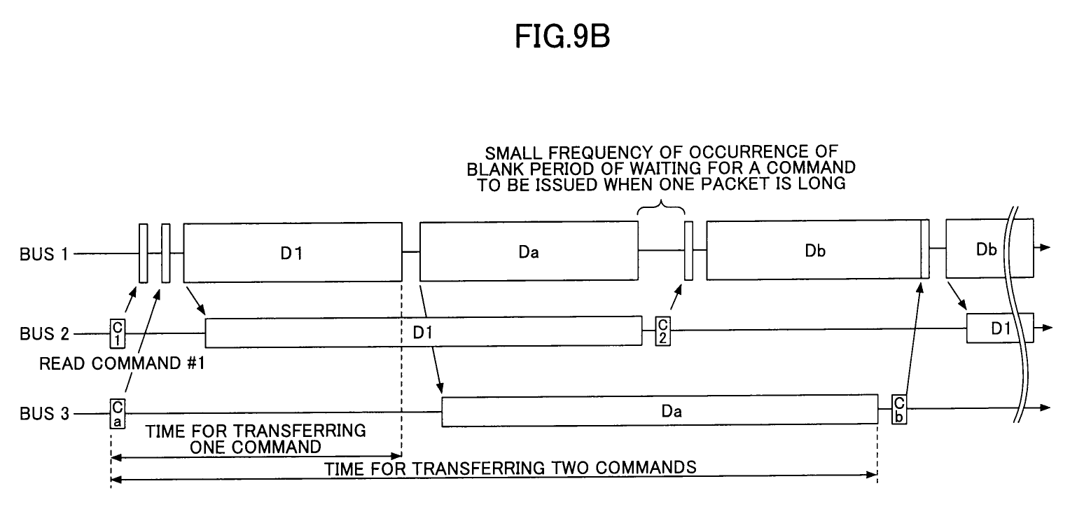

FIGS. 9A and 9B show timing charts for the data transfer for large and small units (packets) of transferring data. FIG. 9A is a timing chart with no pre-casting of read commands for the data transfer for small packets. FIG. 9B is a timing chart with no pre-casting of read commands for the data transfer for large packets.

As shown in FIG. 9A, in the bus switch 107, when a packet is small (short), the frequency of occurrence of a blank time period of waiting for a read command to be issued on “the bus 1” becomes larger, causing the efficiency of transferring data to deteriorate. On the other hand, as shown in FIG. 9B, in the bus switch 107, when a packet is large (long), the frequency of occurrence of a blank period of waiting for a read command to be issued on “the bus 1” becomes smaller, thus improving the efficiency of transferring data.

In this way, in the bus switch 107 according to the present invention, when the packet is longer, the frequency of occurrence of the blank period of waiting for the read command to be issued on “the bus 1” becomes smaller, allowing the blank period to be ignored and effectively utilizing the bus bandwidth of “the bus 1”, thus improving the efficiency of transferring data.

The present invention is not limited to the specific embodiments disclosed, so that various variations and changes are possible without departing from the claims. For example, the bus switch 107, which is shown as having three ports, is not limited to having three ports, so that it may be arranged to have no less than four ports. Moreover, the number of bus lanes (4, 8) is merely an example, so that it may take different numbers of bus lanes.

### Embodiment 2

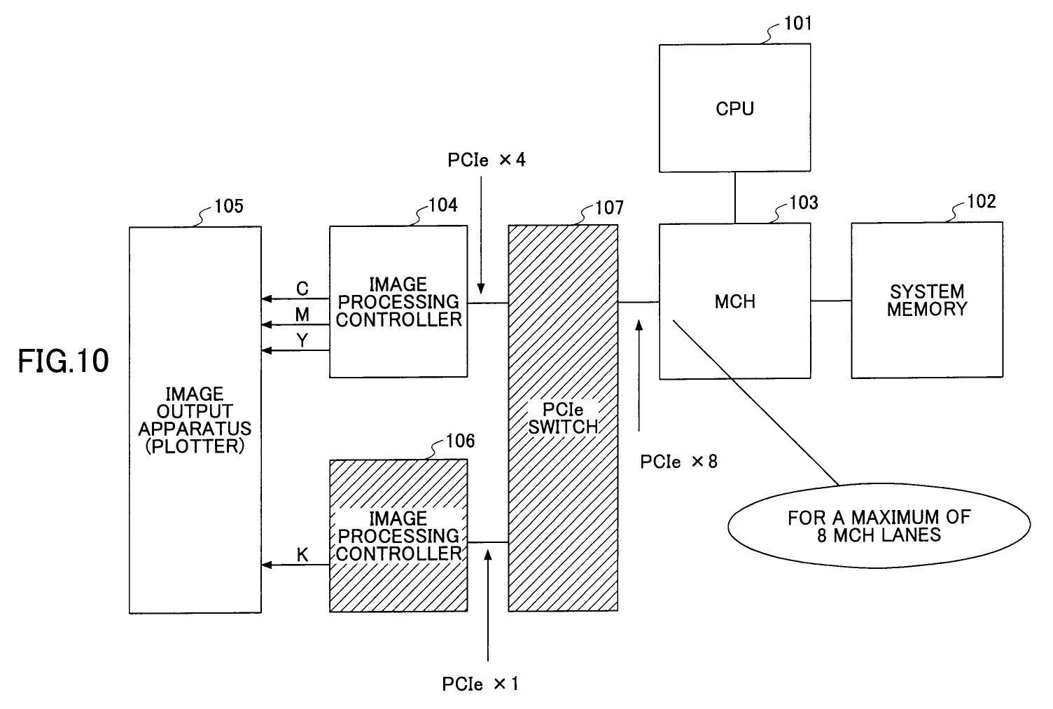

FIG. 10 is a schematic drawing of another embodiment of the printer according to the present invention. The schematic drawing in FIG. 10 omits some of the parts which are not necessary for explaining the present invention. The printer in FIG. 10 is arranged to have a CPU 101, a system memory 102, an MCH 103, an image processing controller 104, an image output apparatus 105, an image processing controller 106, and a PCIe bus switch 107.

Except for some of the features, the printer shown in FIG. 10 is arranged to have the same features as the printer in FIG. 2. The printer in FIG. 10 differs from the printer in FIG. 2 in that the image processing controller 106 is connected to the bus switch 107 with a PCIe lane, and that the image processing controller 104 is in charge of the C, M, and Y planes while the image processing controller 106 is in charge of the K plane.

In other words, in the printer shown in FIG. 10, the number of lanes connecting the image processing controller 104 and the bus switch 107 differs from the number of lanes connecting the image processing controller 106 and the bus switch 107. In other words, in the printer shown in FIG. 10, the transfer rate between the image processing controller 104 and the bus switch 107 differs from the transfer rate between the image processing controller 106 and the bus switch 107.

Moreover, in the printer shown in FIG. 10, as in the same manner as in the printer in FIG. 2, the number of lanes connecting the MCH 103 and the bus switch 107 is larger than the number of lanes connecting the image processing controller 104 or 106 and the bus switch 107.

The printer shown in FIG, 10 is connected to multiple modules (the image processing controllers 104 and 106) allowing load to be distributed to enhance the data transfer performance. In the printer shown in FIG. 10, as in the printer shown in FIG. 2, the existing image processing controllers 104, 106 with 1 PCIe lane or 4 PCIe lanes may be used, making it possible to minimize the development cost, personnel, manpower, and risk to improve the data transfer performance of PCIe. Thus, in the printer as shown in FIG. 10, the equipment performance may easily be improved.

In the printer as shown in FIG. 2, the transfer rate between the image processing controller 104 and the bus switch 107 is equal, so that, as in the timing chart shown in FIG. 8, the bus 2 and bus 3 evenly share the bandwidth of the bus 1.

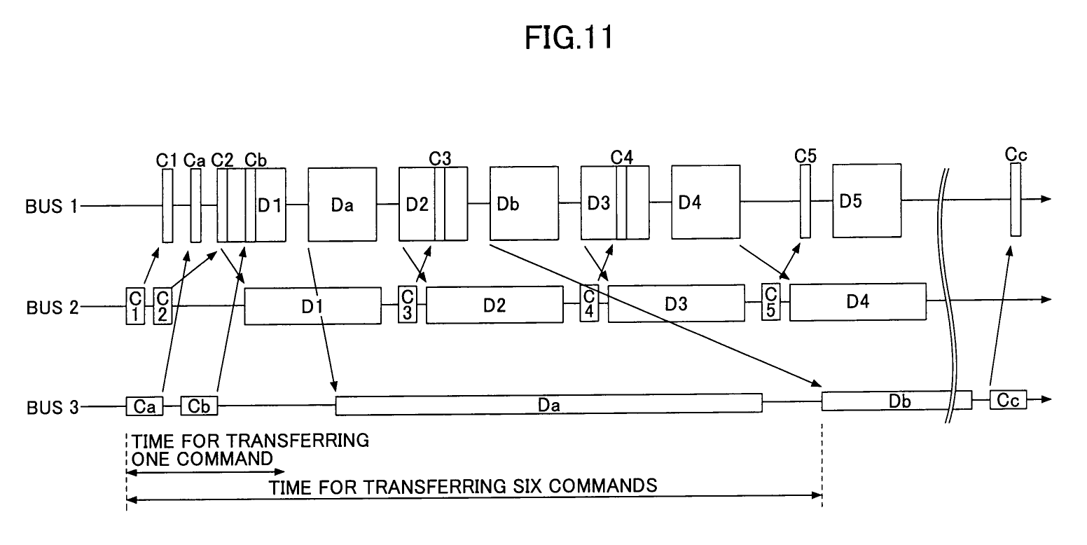

On the other hand, in the printer shown in FIG. 10, the transfer rate between the image processing controller 104 and the bus switch 107 differs from the transfer rate between the image processing controller 106 and the bus switch 107, resulting in a timing chart as shown in FIG. 11.

FIG. 11 is a timing chart with different transfer rates for data transfer performed in the printer according to the present invention. In FIG. 11, as in FIG. 8, a PCIe bus between the MCH 103 and the bus switch 107 is shown as “bus 1”, a PCIe bus between the image processing controller 104 and the bus switch 107 is shown as “bus 2”, and a PCIe bus between the image processing controller 106 and the bus switch 107 is shown as “bus 3”.

In a manner similar to the timing chart of FIG. 8, the timing chart of FIG. 11 shows operations of the buses 1-3 for reading output image data from the system memory 102 upon the image processing controllers 104 and 106 receiving a start request from the CPU 101.

In the timing chart of FIG. 11, upon receiving a start request from the CPU 101, as in a manner similar to the timing chart of FIG. 8, the image processing controllers 104 and 106 first pre-cast the read commands.

First, the CPU 101 accesses registers (not shown) within the image processing controllers 104 and 106, and starts the image processing controllers 104 and 106. The image processing controller 104 issues read commands (C1, C2) for the system memory 102 via the bus 2 to the MCH 103. The image processing controller 106 issues read commands (Ca, Cb) for the system memory 102 via the bus 3 to the MCH 103. The bus switch 107 sends the received four read commands (C1, Ca, C2, Cb) sequentially to the MCH 103 via bus 1 without processing.

The MCH 103, upon receiving the read commands (C1, Ca, C2, Cb), reads data of designated addresses (D1, Da, D2, Db) from the system memory 102. The MCH 103 returns the read data sets (D1, Da) from the system memory 102 as PCIe responses to the read commands (C1, Ca) via the bus 1 to the bus switch 107.

FIG. 8 shows an example of the buffers 204 and 205 having one transfer size. Therefore, at this time, the data read (D2, Db) from the system memory 102 is not returned to the bus switch 107.

The bus switch 107 returns the received data (D1) to the image processing controller 104, from which the read command (C1) is requested, via the bus 2. Moreover, the bus switch 107 returns the received data (Da) to the image processing controller 106, from which the read command (Ca) is requested, via the bus 3.

However, the transfer rate on the bus 3 between the image processing controller 106 and the bus switch 107 is lower than the transfer rate on the bus 2 between the image processing controller 104 and the bus switch 107, so that the transfer of the data (Da) on the bus 3 will not be completed for some time even when the transfer of the data (D1) on the bus 2 is completed.

While data (D1) received from the bus switch 107 is image-processed to pass on to the image output apparatus 105, the image processing controller 104 issues a next read command (C3). In this way, upon completing the transfer of one data set from the bus switch 107, the image processing controller 104 issues a next read command.

Meanwhile, after receiving data (Da, Db) from the bus switch 107, the image processing controller 106 issues a next read command (Cc). After first issuing two read commands (Ca, Cb), the image processing controller 106 does not issue a next read command (Cc) for some time. During this time, bus 2 may use bus 1 intermittently to transfer data.

In the printer as shown in FIG. 10, the transfer rate between the image processing controller 104 and the bus switch 107 differs from the transfer rate between the image processing controller 106 and the bus switch 107, so that, as in the timing chart shown in FIG. 11, bus 2 uses the bandwidth of bus 1 more often than bus 3.

### Embodiment 3

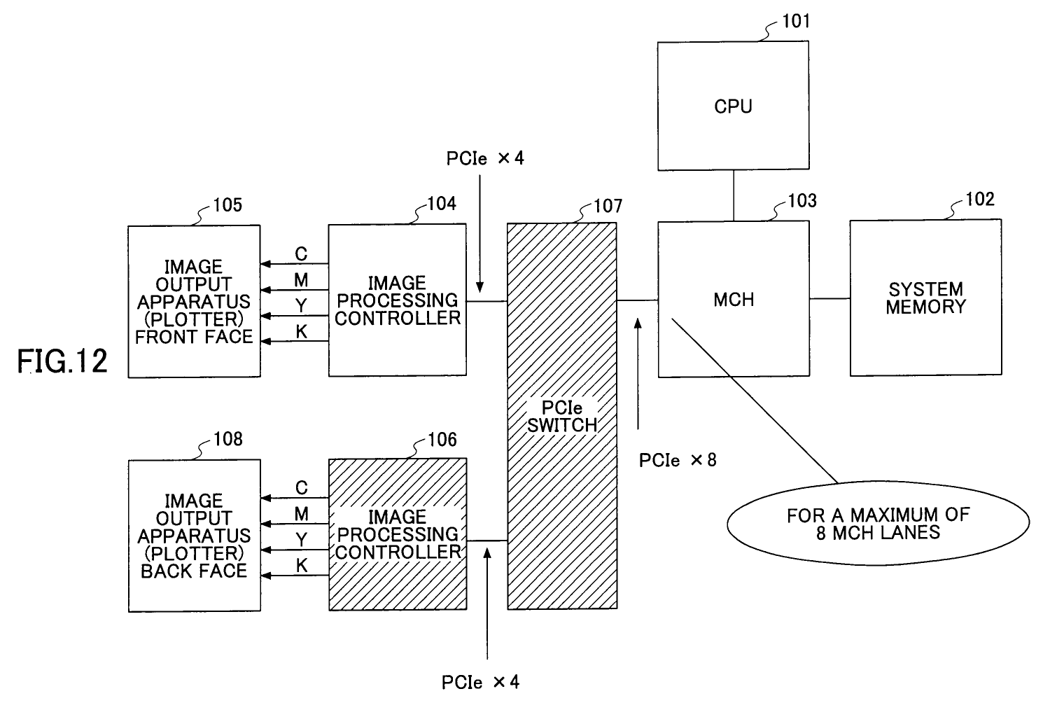

FIG. 12 is a schematic drawing of a further embodiment of the printer according to the present invention. The schematic drawing in FIG. 12 omits some of the parts which are not necessary for explaining the present invention. The printer in FIG. 12 is arranged to have a CPU 101, a system memory 102, an MCH 103, an image processing controller 104, an image output apparatus 105, an image processing controller 106, a PCIe bus switch 107, and an image output apparatus 108.

Except for some of the features, the printer shown in FIG. 12 is arranged to have the same features as the printer in FIG. 2. The printer shown in FIG. 12 differs from the printer in FIG. 2 in that the image processing controllers 104 and 106 divide up serving of C, M, Y, and K planes, and the image processing controller 106 is connected not to the image processing apparatus 105 but to the image output apparatus 108.

The printer shown in FIG. 12 is capable of simultaneously printing both sides with the image processing controller 104 in charge of the front side and the image processing controller 106 in charge of the back side. In the printer shown in FIG. 12, multiple modules allowing load to be distributed (the image processing controllers 104, 106) are connected to the bus switch 107 to enhance the data transfer performance, while the image processing controller 104 is in charge of the front side and the image processing controller 106 is in charge of the back side in simultaneously printing both sides, thus enhancing the printing functions as well.

The memory control unit as recited in the claims correspond to the MCH 103, the processing control unit corresponds to the image processing controllers 104, 106, the first data transmitting and receiving unit corresponds to the ports 202 and 203, and the second data transmitting and receiving unit corresponds to the port 201.

The present application is based on the Japanese Priority Applications No. 2007-304430 filed on Nov. 26, 2007, and No. 2008-257428 filed on Oct. 2, 2008, the entire contents of which are hereby incorporated by reference.

1. A serial transfer interface bus switch provided between a memory control unit which controls reading and writing of data with the memory, and a plurality of process control units which process the data, comprising:
at least one first data transmitting and receiving units provided for each of the process control units for controlling data transmitting and receiving with the process control units;
a second transmitting and receiving unit which controls data transmitting and receiving with the memory control unit; and
a switching unit which switches between a connection to the at least one first data transmitting and receiving unit and a connection to the second data transmitting and receiving unit, wherein
the at least one first data transmitting and receiving unit has a buffer of a size no less than an amount of data which can be transferred with the memory in one instruction from the process control units.

2. The bus switch as claimed in claim 1, wherein the first data transmitting and receiving unit receives a next read instruction from the process control units before transmitting to the process control units data read from the memory with one read instruction from the process control units.

3. The bus switch as claimed in claim 1, wherein a transfer rate of the second data transmitting and receiving unit connected to the memory control unit is no less than N times a transfer rate of the first data transmitting and receiving unit connected to N process control units.

4. The bus switch as claimed in claim 1, wherein a transfer rate of the second data transmitting and receiving unit connected to the memory control unit is no less than a sum of transfer rates of N first data transmitting and receiving units connected to N process control units.

5. The bus switch as claimed in claim 1, wherein the plurality of process control units have the same functions, with the plurality of process control units dividing up and handling the data.

6. An electronic equipment unit having a memory control unit which controls reading and writing of data with a memory, and a plurality of process control units which process the data, comprising:
a serial-transfer interface bus switch between the memory control unit and the plurality of process control units, the bus switch having:
at least one of first data transmitting and receiving units provided for each of the process control units for controlling data transmitting and receiving with the process control units;
a second transmitting and receiving unit which controls data transmitting and receiving with the memory control unit; and
a switching unit which switches between a connection to the at least one first data transmitting and receiving unit and a connection to the second data transmitting and receiving unit, wherein the at least one first data transmitting and receiving unit has a buffer of a size no less than an amount of data which can be transferred with the memory in one instruction from the process control units.

7. The electronic equipment unit as claimed in claim 6, wherein the first data transmitting and receiving unit receives a next read instruction from the process control units before transmitting to the process control units data read from the memory with one read instruction from the process control units.

8. The electronic equipment unit as claimed in claim 6, wherein a transfer rate of the second data transmitting and receiving unit connected to the memory control unit is no less than N times a transfer rate of the first data transmitting and receiving unit connected to N process control units.

9. The electronic equipment unit as claimed in claim 6, wherein a transfer rate of the second data transmitting and receiving unit connected to the memory control unit is no less than a sum of transfer rates of N first data transmitting and receiving units connected to N process control units.

10. The electronic equipment unit as claimed in claim 6, wherein the plurality of process control units have the same functions, with the plurality of process control units dividing up and handling the data.

11. The electronic equipment unit as claimed in claim 6, wherein the electronic equipment unit is an image processing apparatus having a plotter.

12. A method of transferring data in a serial transfer interface bus switch provided between a memory control unit which controls reading and writing of data with a memory, and a plurality of process control units which process the data, comprising the steps of:
receiving from the process control units, by at least one of first data transmitting and receiving units which control data transmitting and receiving with the process control units, an instruction of reading from the memory;
transmitting, by the second data transmitting and receiving unit which controls transmitting and receiving of data with the process control units, the reading instruction to the memory control unit;
receiving from the memory control unit, by the second data transmitting and receiving unit, the data read from the memory according to the reading instruction;
transmitting, by a switching unit which switches between a connection to the at least one first data transmitting and receiving unit and a connection to the second data transmitting and receiving unit, the data received from the memory control unit to the at least one first data transmitting and receiving unit which transmitted the reading instruction; and
transmitting, by the first transmitting and receiving unit, the data to the process control units using a buffer of a size no less than an amount of data which can be transferred with the memory with one instruction from the process control units.

13. The method of transferring data as claimed in claim 12, further including the step of receiving a next read instruction from the process control units before transmitting to the process control units data read from the memory with one read instruction from the process control units.

14. The method of transferring data as claimed in claim 12, wherein a transfer rate of the second data transmitting and receiving unit connected to the memory control unit is no less than N times a transfer rate of the first data transmitting and receiving unit connected to N process control units.

15. The method of transferring data as claimed in claim 12, wherein a transfer rate of the second data transmitting and receiving unit connected to the memory control unit is no less than a sum of transfer rates of N first data transmitting and receiving units connected to N process control units.

16. The method of transferring data as claimed in claim 12, wherein the plurality of process control units have the same functions, with the plurality of process control units dividing up and handling the data.
